(19) United States
(12) Patent Application Publication
(10) Pub. No.: US 2014/0103886 A1
(43) Pub. Date: Apr. 17, 2014

(54) Method for producing reactive current with a converter and converter arrangement and energy supply plant

(71) Applicant: UNIVERSITAET KASSEL, Kassel (DE)

(72) Inventors: Sigfried Heier, Baunatal (DE); Jean Patric Da Costa, Kassel (DE); Christoph Dziendziol, Fuldatal (DE)

(73) Assignee: UNIVERSITAET KASSEL, Kassel (DE)

(21) Appl. No.: 13/955,294

(22) Filed: Jul. 31, 2013

Related U.S. Application Data
(63) Continuation-in-part of application No. PCT/EP2012/051645, filed on Feb. 1, 2012.

(30) Foreign Application Priority Data
Feb. 2, 2011 (DE) 10 2011 000 459.9

(51) Int. Cl. H02M 1/42

(52) U.S. Cl. CPC H02M 1/4208
USPC 323/207

(57) ABSTRACT

in a method for producing reactive current with a converter (4), a generator-side converter unit (41) and a system-side converter unit (43) are connected to one another via a DC voltage intermediate circuit (42). In a normal operating state, the converter (4) serves to convert and feed an electrical power produced by a generator (2, 2′) into an energy supply system (7), and in a faulty operating state serves to provide electrical reactive current to the energy supply system (7). The generator-side converter unit (41) is isolated from the generator (2, 2′) and the generator-side converter unit (41) is connected to the energy supply system (7). A reactive current is provided to the energy supply system (7) by means of the system-side converter unit (41) and the generator-side converter unit (43).

### CROSS-REFERENCE TO A RELATED APPLICATION

This is a Continuation in Part of International Application PCT/EP 2012/051645 filed on Feb. 1, 2012. The invention described and claimed hereinbelow is also described in German patent Application 10 2011 000 459.9 filed on Feb. 2, 2011. This German Patent Application, whose subject matter is incorporated here by reference, provide the basis for a claim of priority of invention under 35 U.S.C. 119 (a)-(d).

The invention relates to a method for producing reactive current during a fault of an energy supply system with a converter, which has a generator-side converter unit and a system-side converter unit, which are connected to one another via a DC voltage intermediate circuit. The invention furthermore relates to a converter arrangement and an energy supply plant, which are designed for implementing the method.

The generators of regenerative energy supply plants, for example wind power plants or solar energy plants, provide the electrical power generated thereby generally in a form which is not suitable for being fed directly to an energy supply system, for example, an alternating current with a variable frequency which is dependent on the rotation speed of the rotor in the case of a wind power plant or in the form of direct current in the case of a photovoltaic generator of a solar plant. In order to convert the current into an alternating current suitable for being fed into the energy supply system with an appropriate voltage, frequency and phase angle, converters of the type mentioned at the outset are used, in which a generator-side converter unit and a system-side converter unit are connected to one another via a DC voltage intermediate circuit. The DC voltage intermediate circuit in this case generally has a capacitor as energy buffer store, which enables a pulsed current consumption by the main system-side inverter. Depending on the form of the current generated by the generator (for example direct current or alternating current; voltage level, etc.), the generator-side converter unit in this case functions as a step-up or step-down converter or as a rectifier bridge, for example.

As regenerative energy generation plants are becoming increasingly widespread, the demands placed by energy supply companies on the parameters of the current provided increase. The demands are specified in so-called system connection guidelines (grid code). While regenerative energy generation plants could in the past still be disconnected in the event of system faults, for example in the event of voltage dips, since then there has been a demand to be connected to the energy supply system in the case of system faults and to ride through the system faults (FRT-fault ride through), with the result that at the end of the system fault, power can be fed into the energy supply system again immediately, where possible. In this case, in particular, the capacity is required to feed reactive current and reactive power associated therewith, in particular capacitive reactive power for assisting the system voltage, into the energy supply systems. At present, system connection guidelines are conventional, for example, in which there is a demand placed on the regenerative energy generation plants whereby a reactive current with a level which corresponds to the rate current of the energy generation plant during normal operation can be produced. The provision of a regenerative energy generation plant is associated with this reactive current.

Regenerative energy generation plants have until now been able to cope with this demand by virtue of a converter of the type mentioned at the outset being used, in which the system-side converter unit is actuated in the event of a fault in such a way that it provides a reactive current. A converter unit can produce the required reactive current at the level of the rated current without a change in the dimensions of its switching elements, usually power semiconductors such as MOSFETs (metal oxide semiconductor field-effect transistors), IGBTs (insulated gate bipolar transistors), GTOs (gate turn-off thyristors) or MCTs (MOS-controlled thyristors). However, it would be desirable to be able to provide a reactive current greater than the rated current. However, this would require power semiconductors with a higher current-carrying capacity with the known converters, which would result in an increase in costs in the manufacture of the converters.

Therefore, an object of the present invention consists in providing a method for producing a reactive current during a fault of the energy supply system to be able to ride through the fault with a converter of the type mentioned at the outset, in which the converter in a normal operating state serves to convert and feed an electrical power produced by a generator into an energy supply system and in a faulty operating state to provide reactive current to the energy supply system, wherein a reactive current above and beyond the rated current of the converter can be produced without power semiconductors used in the converter needing to be designed to have a higher current-carrying capacity. A further object consists in specifying a converter arrangement and an energy supply plant which are designed for implementing the method.

This object is achieved by a method, a converter arrangement and an energy supply plant having the features of the independent claims. Developments and advantageous configurations are specified in the respective dependent claims.

In accordance with a first aspect, the object is achieved by a method for producing reactive current with a converter, wherein the converter has a generator-side converter unit and a system-side converter unit, which are connected to one another via a DC voltage intermediate circuit, and in which the converter in a normal operating state serves to convert and feed an electrical power produced by a generator into an energy supply system, and in a faulty operating state serves to provide electrical reactive current to the energy supply system. The method has the following steps: the generator-side converter unit is isolated from the generator and connected to the energy supply system. Then, reactive current is provided by the system-side converter unit and the generator-side converter unit to the energy supply system during the power supply system fault.

By virtue of isolating the generator-side converter unit from the generator and connecting said generator-side converter unit to the energy supply system, both converter units can be used for reactive current provision and not only the system-side converter unit, as has previously been the case. Starting from the same current-carrying capacity for both converter units, the level of the reactive current which can be provided can be doubled in this way without power semiconductors with a higher current-carrying capacity needing to be used for the converter. With the aid of the method, an energy supply plant with substantially identical components can provide an increased reactive current and therefore an increased short-circuiting power for supporting the energy supply system in the event of a fault.

In accordance with an advantageous configuration of the method, a switchover time for providing the reactive current is short enough for enabling a fault ride through (FRT) of the power supply system fault.

In accordance with an advantageous configuration of the method, the system-side converter unit is connected to the energy supply system via a filter, and the generator-side converter unit is connected to the energy supply system via a further filter in the faulty operating state. In this way, the provision of double the reactive current can take place without the filter generally provided for smoothing, which is also referred to as a sine-wave filter, being designed for twice the current loading, which would impair its filter properties during normal operation.

In accordance with a second aspect, the object is achieved by a converter arrangement for feeding an electrical power provided by a generator into an energy supply system, comprising a converter, which has a generator-side converter unit and a system-side converter unit, which are connected to one another via a DC voltage intermediate circuit. The converter arrangement is characterized by the fact that a changeover switch is provided, via which the generator-side converter unit can be connected either to the generator or to the energy supply system. Such a converter arrangement makes it possible to implement the abovementioned method.

In accordance with a third aspect, the object is achieved by an energy supply plant with such a converter arrangement. The advantages of the converter arrangement and the energy supply plant correspond to those relating to the described method.

The invention will be explained in more detail below with reference to exemplary embodiments with the aid of three figures, in which:

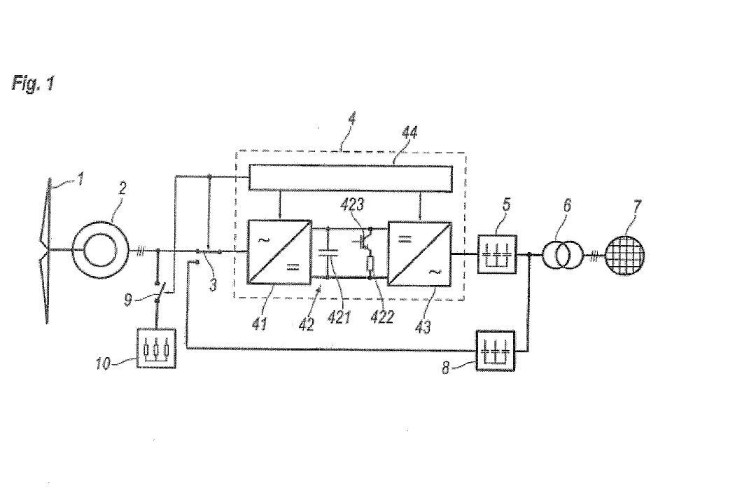

FIG. 1 shows a schematic block circuit diagram of a wind power plant with a synchronous generator and a full converter,

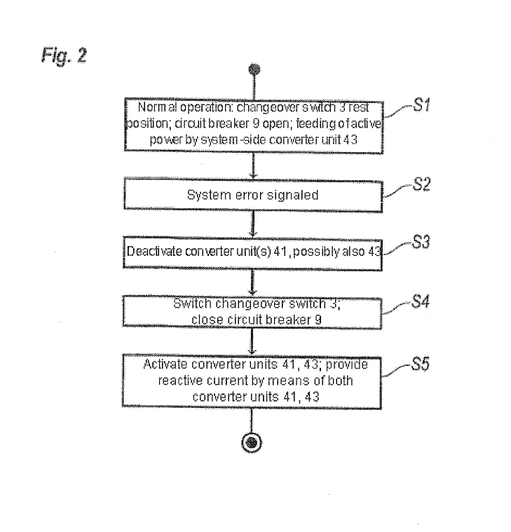

FIG. 2 shows a flowchart of a method for providing reactive current, and

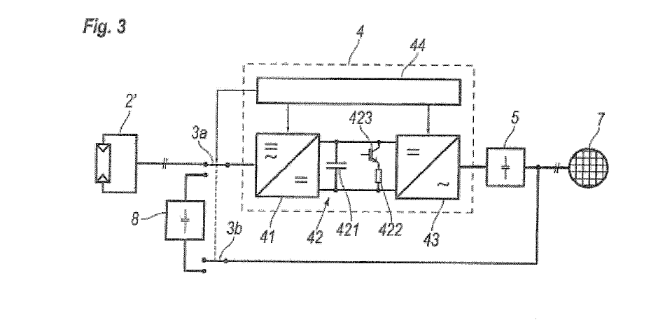

FIG. 3 shows a schematic block circuit diagram of a photovoltaic plant.

FIG. 1 shows a wind power plant as a first exemplary embodiment of an energy supply plant according to the invention in a schematic block circuit diagram.

The wind power plant has rotor blades 1, which are coupled to a rotor of a generator 2. This coupling can be performed directly or via an optional gear mechanism (not shown in the figure). The generator 2 is electrically connected with stator windings to a converter 4 via a changeover switch 3, which converter 4 is again connected via a filter 5 and a transformer 6 to an energy supply system 7 for feeding electrical energy into said energy supply system. In this case, the filter 5 serves to shape the AC signal and is therefore also referred to as a sine-wave filter. It has capacitive and possibly inductive elements. It is noted that, in an energy supply plant in accordance with the application, it is not absolutely necessary for a transformer to be provided. A method according to the invention can also be implemented using a converter, which is designed for direct feeding without any galvanic isolation. The filter 5, depending on the embodiment of the converter, does not absolutely need to be provided either. Likewise, by way of example, the electrical connections are illustrated in three-phase form. However, the wind power plant can likewise be designed for any desired number of phases, in particular for one or two electrical phases, as further regenerative energy supply plants in accordance with the application. In addition, further elements can be arranged between the converter 4 and the energy supply system 7, for example protective elements or isolating elements, whose use is known in principle or is prescribed in energy generation plants and which have not been reproduced in the figure for clarity of illustration.

The generator 2 in the exemplary embodiment shown in FIG. 1 is, by way of example, a permanent magnet synchronous generator, which provides an AC voltage at its output with a frequency which is dependent on the rotation speed of the rotor blades 1. In the exemplary embodiment illustrated, the total electrical current generated is routed via the converter 4, which is therefore also referred to as a full converter. However, mention is now made of the fact that the method according to the invention can be implemented in connection with any energy supply plant in which electrical power generated is routed entirely or partially via a converter into an energy supply system. In particular, an asynchronous generator with a squirrel-cage rotor which is likewise operated with a full converter can be used as generator. The use of a double-fed asynchronous generator (DASG) is also possible, whereby not the total current but only the rotor current is routed via a converter, however.

The converter 4 has a generator-side converter unit 41, which, in the exemplary embodiment illustrated, converts the alternating current supplied by the generator 2 into a direct current. The DC output of the generator-side converter unit 41 is connected to a DC voltage intermediate circuit 42, which has a capacitor 421 for smoothing the voltage in this DC voltage intermediate circuit 42. Furthermore, the converter has a system-side converter unit 43, which is in the form of a DC-to-AC converter. On the DC voltage side, the system-side converter unit 43 is connected to the DC voltage intermediate circuit 42 and, on the AC side, is connected to the filter 5.

Furthermore, in the case of the converter 4, a control device 44 is provided which actuates, inter alia, the generator-side converter unit 42 and the system-side converter unit 34. Both converter units 42, 43 generally have a semiconductor power output stage with one or more half-bridges or full-bridges. The power semiconductor switches of the system-side converter unit 43 are in this case actuated via the control device 44 in such a way that energy is fed from the DC voltage intermediate circuit 42 with a suitable voltage, frequency and phase angle into the energy supply system 7.

In the first exemplary embodiment shown, the generator-side converter unit 41 serves during normal operation to rectify the alternating current provided by the generator 2. This would be possible in principle also with diodes, i.e. elements which are not actively switchable. The generator-side converter unit 41 is nevertheless equipped with active switching elements which are actuated by the control device 44. This is necessary firstly for implementing the method according to the application, as is described further below, but is also secondly advantageous during normal operation, for example for regulating the voltage in the DC voltage intermediate circuit 42. In order to correctly adjust the parameters of the fed current, the system voltage of the energy supply system 7 is generally also supplied to the control device 44, which is not illustrated in the figure for reasons of clarity. In addition, generally different voltage and/or current sensors are provided on the generator side, the system side and in the DC voltage intermediate circuit. These sensors are likewise not illustrated in this figure or in the exemplary embodiment illustrated below, for reasons of clarity.

In addition to controlling the converter 4, the control device 44 also serves to actuate the changeover switch 3. In the rest state of the changeover switch 3, which is assumed during normal operation of the wind power plant, the changeover switch 3 connects the current-providing connections of the generator 2 to the generator-side converter unit 41 of the converter 4 for converting and ultimately feeding the electrical energy generated by the generator 2 into the energy supply system 7. The changeover switch is preferably an electromagnetically activated contactor. However, other switching elements, for example, semiconductor switches, can also be used as changeover switch 3.

In a faulty operating state in which reactive current is intended to be provided to the power supply system 7 in the case of system faults, the changeover switch 3 is activated via the control device 44. By virtue of the activation of the changeover switch 3, the generator-side converter unit 41 is connected with its AC input via a further filter 8 and via the transformer 6 to the energy supply system 6.

On activation of the changeover switch 3, in addition the actuation of the generator-side converter unit 41 and the system-side converter unit 43 is additionally changed by the control device 44 in such a way that reactive current is provided to the energy supply system 7. The changeover switch 3, in combination with the corresponding actuation of the power semiconductor switches, therefore makes it possible for the generator-side converter unit 41 to provide a reactive current to the energy supply system 7 as well, in addition to the system-side converter unit 43. The reactive current which can be provided by the energy supply plant in the event of a system fault can thus be twice as high as the rated current. If, in this case, an active current or active power flow from the energy supply system 7 into the DC voltage intermediate circuit 42 is established, electrical power can be drawn from the DC voltage intermediate circuit 42 via a discharge resistor 422 provided in the DC voltage intermediate circuit 42 by corresponding actuation of a discharge switch 423 connected in series with said discharge resistor, as in the exemplary embodiment illustrated. The system is designed such that the time needed to switch to a state in which reactive power is delivered, called switchover time in the following, is short enough for being able to ride through a fault of the energy supply system. Since a fault of the energy supply system can occur at any time, a switch over can take place during normal operation of the power plant, i.e. can take place while the power produces energy. For fault ride through (FRT) capability, switchover times of less than a few seconds and preferably less than a few ten to hundred milliseconds are required.

In addition, a protective circuit switch 9 is actuated by the control device 44 in the faulty operating state, via which protective circuit switch the generator 2 can be connected to a protective circuit 10. The protective circuit 10 is used for taking up excess kinetic energy which the system comprising the rotor blades 1 and the generator 2 has at the time of activation of the changeover switch 3. Current and voltage peaks at the generator 2 are thus reduced. The protective circuit 10 has, for example, effective resistances in which the power of the generator 2 is converted into thermal energy. In addition, an electronic switching element can be provided in the protective circuit 10, via which electronic element the damping effect of the resistance network can be controlled in a pulse-width modulation method. In order to prevent excessive thermal loading in the resistance network, the rotor blades 1 and the generator 2 can additionally be braked. Measures for this are known from the prior art and include changing the inclination setting of the rotor blades 1, pivoting the alignment of the rotor axis relative to the wind direction or else activating a mechanically effective rotor brake. The protective circuit 10 ensures that even a longer switchover can take place at any time.

FIG. 2 illustrates the method for providing reactive current by means of a converter once again in the form of a flowchart. The method can be implemented, for example, using the wind power plant illustrated in connection with FIG. 1. Therefore, the explanation will be given by way of example with reference to FIG. 1.

In a first step S1, the plant is operated for generating regenerative energy in a normal operating state in which the generator 2 is connected to the converter 4 via the changeover switch 3. The alternating current provided by the generator 2 is converted by the generator-side converter unit 41 into a direct current, which is supplied to the DC voltage intermediate circuit 42 and thus to the capacitor 421. The direct current is converted by the system-side converter unit 43 into an AC voltage, which, after smoothing by the filter 5 and transformation by the transformer 6, is suitable for being fed to the energy supply system 7 in respect of its voltage, frequency and phase angle.

In a second step S2, a system fault is detected by a monitoring and control unit (not illustrated) and signaled to the control device 44 of the converter 4.

In a step S3, the power semiconductor switches at least of the generator-side converter unit 41, optionally also of the system-side converter unit 43, are set to a non-conducting state by the control device 44. The corresponding generator-side converter unit 41 (and possibly also the system-side converter unit 43) thus becomes inactive.

Thereupon, in a following step S4, the changeover switch 3 is activated by the control device 44, as a result of which the generator-side converter unit 41 is connected in parallel with the system-side converter unit 43 via the further filter 8. In addition, in this step S4, the protective circuit switch 9 is activated in order to dissipate the kinetic energy of the generator 2 and of the rotor blades 1 via the protective circuit 10.

In a following step, S5, the control device 44 actuates the power semiconductors of the generator-side converter unit 41 and the system-side converter unit 43 in such a way that reactive current is provided to the energy supply system 7. In addition, the voltage in the DC voltage intermediate circuit 42 is monitored and, in the event that a predetermined limit voltage is exceeded, the discharge switch 423 is activated, if appropriate, in order to discharge the capacitor 421 via the discharge resistor 422.

At the end of the system fault, a signal is again provided to the control device 44 by the monitoring and control device to assume the normal operating state again. Furthermore, steps S5 to S3 and S1 are implemented substantially in reverse sequence: first the actuation of the power semiconductor switches of the generator-side converter unit 41 and the system-side converter unit 43 is suspended so that the two converter units are inactive. Then, both the protective circuit switch 9 and the changeover switch 3 are set to the rest state by the control device 44, i.e. the protective circuit switch 9 is opened and the protective circuit switch 3 is brought into a position in which the generator-side converter unit 41 is connected to the generator 2 again. If appropriate, implemented braking means on the rotor blades 1 or the generator 2 are cancelled. The power semiconductor switches of both the generator-side converter unit 41 and the system-side converter unit 43 are then actuated again in such a way that an active power flow from the generator 2 to the energy supply system 7 takes place and the wind power plant resumes normal operation.

FIG. 3 shows, similarly to FIG. 1, a solar energy plant as a further exemplary embodiment of an energy generation plant with a converter arrangement in accordance with the application. The same reference symbols in this exemplary embodiment denote identical or functionally identical elements to those in the exemplary embodiment shown in FIG. 1.

In the case of the solar energy plant, a photovoltaic generator 2′ is used for current generation. For reasons of clarity, the photovoltaic generator 2′ is symbolized by the switching symbol of a single photovoltaic cell. However, it goes without saying that the photovoltaic generator 2′ can represent a series and/or parallel circuit comprising a large number of photovoltaic modules, which for their part can have a plurality of photovoltaic cells.

An element for drawing active power from the generator in the faulty operating state, which element corresponds to the protective circuit switch 9 and the protective circuit 10 of the wind power plant shown in FIG. 1 is not provided here. If the photovoltaic generator 2′ is not connected to the converter 4, the no-load voltage of the photovoltaic generator 2′ is provided at the output of said photovoltaic generator 2′. Should this be undesirable, for example for safety reasons, a switch similar to the protective circuit switch 9 can be provided, but this switch can in this case be in the form of a short-circuiting switch and short-circuits the photovoltaic generator 2′.

In contrast to the exemplary embodiment shown in FIG. 1, the solar energy plant is in this case designed for direct feeding, without galvanic isolation, on one phase of the energy supply system 7. It goes without saying that a polyphase design, possibly with transformer, would likewise be possible here.

Since the photovoltaic generator 2′ provides direct current at its outputs, the converter 4 is not configured as a frequency converter but as an inverter with a step-up or step-down stage as a generator-side converter unit 41. In this case, the generator-side converter unit 41 has an H switching bridge, also referred to as a full-wave switching bridge. Thus, not only direct current but also alternating current can be applied in principle to the input of said bridge.

Whether the generator-side converter unit 41 operates as a step-up DC-to-DC converter or as a step-down DC-to-DC converter or as an AC-to-DC converter is merely dependent on the type of actuation of its power semiconductor switches by the control device 44. While it operates as a DC-to-DC stage in the normal operating state, in the faulty operating state, after activation of the changeover switch 3, the provision of reactive current to the energy supply system 7 in an operating mode as AC-to-DC converter is possible, as described in connection with FIGS. 1 and 2.

A further difference with respect to the exemplary embodiment shown in FIG. 1 relates to the further filter 8. The changeover switch 3 has two sets of contacts 3a, 3b wherein the connection of the further filter 8 to the energy supply system 7 is implemented via the second set of contacts 3b in such a way that the further filter 8 is only connected to the energy supply system 7 in the faulty operation case. In this way, it is possible to prevent the further filter 8 from negatively influencing the filter properties of the filter 5 under certain circumstances in the normal operating state.

### LIST OF REFERENCE SYMBOLS

1 Rotor blade
2 Generator
2′ Photovoltaic generator
3 Changeover switch
4 Converter
41 Generator-side converter unit
42 DC voltage intermediate circuit
421 Capacitor
422 Discharge resistor
423 Discharge switch
43 System-side converter unit
44 Control device
5 Filter
6 Transformer
7 Energy supply system
8 Further filter
9 Protective circuit switch
10 Protective circuit resistance

1. A method for producing reactive current during a fault of an energy supply system with a converter (4), which has a generator-side converter unit (41) and a system-side converter unit (43), which are connected to one another via a DC voltage intermediate circuit (42), wherein the converter (4)
in a normal operating state serves to convert and feed an electrical power produced by a generator (2, 2′) into an energy supply system (7), and
in a faulty operating state serves to provide electrical reactive current to the energy supply system (7),
having the following steps:
isolating the generator-side converter unit (41) from the generator (2, 2′),
connecting the generator-side converter unit (41) to the energy supply system (7), and
providing reactive current to the energy supply system (7) by means of the system-side converter unit (41) and the generator-side converter unit (43).

2. The method as claimed in claim 1, wherein a switchover time for providing the reactive current is short enough for enabling a fault ride through (FRT) of the power supply system fault.

3. The method as claimed in claim 1, wherein the system-side converter unit (41) and the generator-side converter unit (43) have power semiconductor switches, and wherein, in the faulty operating state, the provision of reactive current is performed by suitable actuation of the power semiconductor switches of the system-side converter unit (41) and the generator-side converter unit (43).

4. The method as claimed in claim 1, wherein the system-side converter unit (41) is connected to the energy-supply system (7) via a filter (5), and wherein the generator-side converter unit (41) is connected to the energy supply system (7) in the faulty operating state via a further filter (8).

5. A converter arrangement for feeding an electrical power provided by a generator (2, 2′) into an energy supply system (7) during a during a fault of an energy supply system comprising a converter (4), which has a generator-side converter unit (41) and a system-side converter unit (43), which are connected to one another via a DC voltage intermediate circuit (42), characterized in that a changeover switch (3) is provided, via which the generator-side converter unit (41) can be connected either to the generator (2, 2′) or to the energy supply system (7).

6. The converter arrangement as claimed in claim 5, characterized in that the converter (4) has a control device (44), which is connected to the changeover switch (4) for actuation thereof, and which is designed to implement a method.

7. The converter arrangement as claimed in claim 6, characterized in that the system-side converter unit (41) and the generator-side converter unit (43) of the converter (4) have power semiconductor switches, which are actuated via the control device (44).

8. The converter arrangement as claimed in claim 5, characterized in that the system-side converter unit (41) is connected to the energy supply system (7) via a filter (5), and in that a further filter (8) is provided, via which the generator-side converter unit (41) is connected to the energy supply system (7) in the faulty operating state.

9. An energy supply plant, having a converter arrangement as claimed in claim 5.

10. The energy supply plant as claimed in claim 9, which is a wind power plant.

11. The energy supply plant as claimed in claim 9, in which the generator (2) is a synchronous generator or an asynchronous generator with a squirrel-cage rotor.

12. The energy supply plant as claimed in claim 9, in which the generator (2) is a double-fed asynchronous generator and the converter (4) is arranged in a rotor circuit.

13. The energy supply plant as claimed in claim 9 which is a solar energy plant.
